(19) United States
(12) Patent Application Publication
(10) Pub. No.: US 2009/0161484 A1
(43) Pub. Date: Jun. 25, 2009

(54) MIXING DEVICE

(76) Inventor: Rosalia G. Tarallo, Tampa, FL (US)

Correspondence Address: ADVANTIA LAW GROUP, 9035 SOUTH 1300 EAST, SUITE 200, SANDY, UT, 84094, US

(21) Appl. No.: 11/963,553

(22) Filed: Dec. 21, 2007

(51) Int. Cl. B01F 13/00

(52) U.S. Cl. 366/342

(57) ABSTRACT

A mixing device for mixing nail polish and other liquids. There is: a tubular housing member; a compressible tubular casing member, disposed in an interior of the tubular housing member; a shaft member, coupled to the tubular housing member; a power module, in communication with the shaft member; and a control module, in communication with the power module, configured to control the provision of energy from the power module to the shaft member. The control module includes a timer module. The compressible tubular casing member is removably disposed in an interior of the tubular housing member. The power module comprises a motor. There is also a storage container, coupled to an end of the shaft member opposite the tubular housing member. The timer module is coupled to an exterior of the storage container; and the power module is disposed within the storage container.

### BACKGROUND OF THE INVENTION

1. Field of the Invention

The present invention relates to mixing devices, specifically nail polish mixing devices for mixing bottles of nail polish.

2. Description of the Related Art

Generally, nail polish is sold in small jars, or bottles. Often, when nail polish bottles are allowed to stand for long periods of time without being used, the polish components separate into layers and/or coagulate, in a manner similar to cans of pain that have not been used for a long time. Furthermore, repeated exposure to the air, caused by opening and closing the bottles can result in thickening and/or coagulation of the polish. Accordingly, prior to the application of nail polish, the polish must be thoroughly mixed to the proper consistency.

Typically, nail polish is mixed just prior to application by shaking the bottle vigorously for several minutes. Many must perform this tedious service by hand. However, such shaking often results in the formation of bubbles and/or foaming in the polish. In addition, mixing and spinning devices are often used to mix nail polish. Some improvements have been made in the field. Examples include but are not limited to the references described below, which references are incorporated by reference herein:

U.S. Pat. No. 5,238,302, issued to Rohan, discloses a special mixing machine readily mixes nail polish and other liquids. The efficient mixing machine has a vibrating head assembly comprising a resilient bonnet with a series of openings to receive bottles or other containers of nail polish or other liquids. The cost effective machine also has motion producing mechanism, such as an eccentrically weighted shaft driven by a motor, which provides a vibrating driver to vibrate the bonnet and rotate (spin) the bottles so as to uniformly mix the nail polish or other liquids without forming undesirable air bubbles and foam.

U.S. Pat. No. 5,399,013, issued to Sawyer, discloses a mixing device for mixing at least one liquid container of nail polish or other liquid comprising a housing to operatively house a container support to support the liquid container thereon disposed in the lower portion thereof coupled to a rotational drive to selectively rotate the container support, a lower container limit to selectively engage the lower portion of the liquid container and an upper container limit to selectively engage the upper portion of the liquid container such that as the container support is rotated about the vertical axis both the lower portion and upper portion of the liquid container translate laterally from the vertical axis to engage the lower container limit and upper container limit respectively creating a wobbling motion to shake and spin the liquid container to thoroughly and rapidly mix the liquid therein.

U.S. Pat. No. 4,479,720, issued to Mochida et al., discloses an apparatus for rotating reaction vessels in an inclined posture, comprising a plate, means for rotatably supporting the plate, means for rotating the plate at a predetermined speed, a plurality of reaction vessel holders mounted on the edge portion of the plate and adapted for mounting reaction vessels, means for rotating the reaction vessel holders around their axes at a predetermined speed, and means for fixing the plate supporting means in such a manner that the reaction vessel holders may be inclined at a predetermined angle to the horizon.

U.S. Pat. No. 3,975,001, issued to Moore et al., discloses a generally upright cylinder is secured at its upper neck by means of a gimbal mount; and its base is driven in circular motion at a substantially constant angular velocity. As a tube of fluid is inserted into the cylinder, the fluid is stirred by the motion of the cylinder; and the intensity of the stirring action increases with the depth to which the tube is inserted into the cylinder. An appliance removably attaches to the apparatus to provide a vibrating platform.

U.S. Pat. No. 3,199,775, issued to Drucker, discloses a sedimentation rate centrifuge and method of determining sedimentation rate. The centrifuge includes a main rotor secured to the upper end of a vertical shaft of an electric motor. A pair of secondary rotors are journaled in the rim so as to be positioned opposite each other on the main rotor and so as to be inclined to the vertical with the tops of the secondary rotors nearer the axis of the main rotor than the bottoms of such secondary rotors. The secondary rotors have spur gears surrounding and secured to their upper portions. The secondary rotors are tubular and each provide and internal bore for receiving a cylindrical sedimentation tube carrier having a plurality of holes extending axially therethrough and spaced radially from the axis of such carrier.

U.S. Design Pat. No. D364,249, issued to, discloses an ornamental design for a nail polish blender/mixer.

The inventions heretofore known suffer from a number of disadvantages, which include: being inconvenient; being difficult to use; not being durable; being ineffective; being impractical; being heavy; not being compact; not saving time and/or being expensive.

What is needed is a mixing device that solves one or more of the problems described herein and/or one or more problems that may come to the attention of one skilled in the art upon becoming familiar with this specification.

### SUMMARY OF THE INVENTION

The present invention has been developed in response to the present state of the art, and in particular, in response to the problems and needs in the art that have not yet been fully solved by currently available mixing devices. Accordingly, the present invention has been developed to provide a mixing device for mixing bottles of nail polish.

In one embodiment of the invention, there is a mixing device for mixing nail polish and other liquids, including: a tubular housing member, configured to house a bottle of nail polish; a compressible tubular casing member, disposed in an interior of the tubular housing member, configured to encase a bottle of nail polish; a shaft member, coupled to the tubular housing member, configured to support the tubular housing member; a power module, in communication with the shaft member, configured to provide energy to the shaft member; and/or a control module, in communication with the power module, configured to control the provision of energy from the power module to the shaft member; wherein the control module includes a timer module. In another embodiment of the invention, the compressible tubular casing member may be removably disposed in an interior of the tubular housing member. In still another embodiment of the invention, the power module includes a motor.

In yet another embodiment of the invention, the mixing device further includes a storage container, coupled to an end of the shaft member opposite the tubular housing member, configured to store accessories for manicures and pedicures. In still yet another embodiment of the invention, the timer module may be coupled to an exterior of the storage container; and/or the power module may be disposed within the storage container.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a front perspective view of a mixing device, according to one embodiment of the invention; and

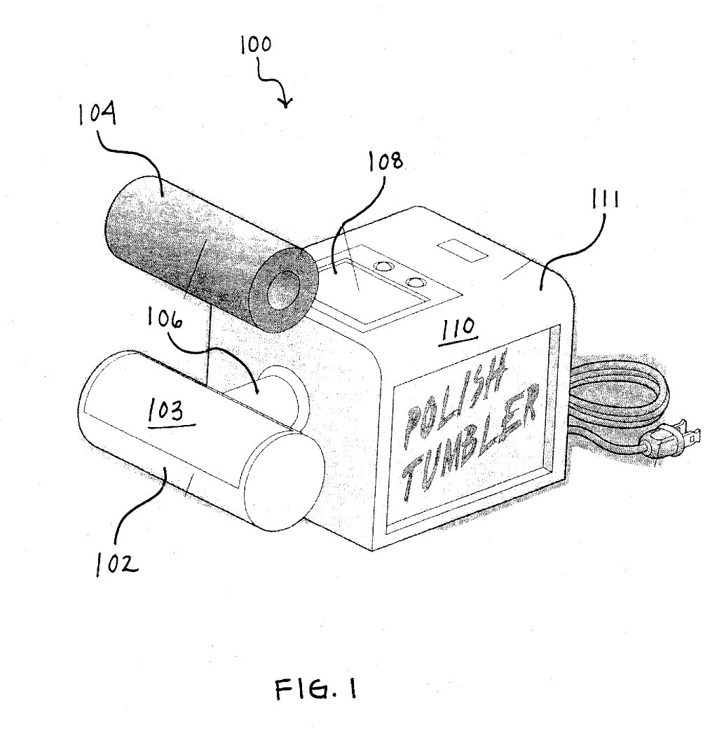

FIG. 2 is a block diagram of a mixing device, according to one embodiment of the invention.

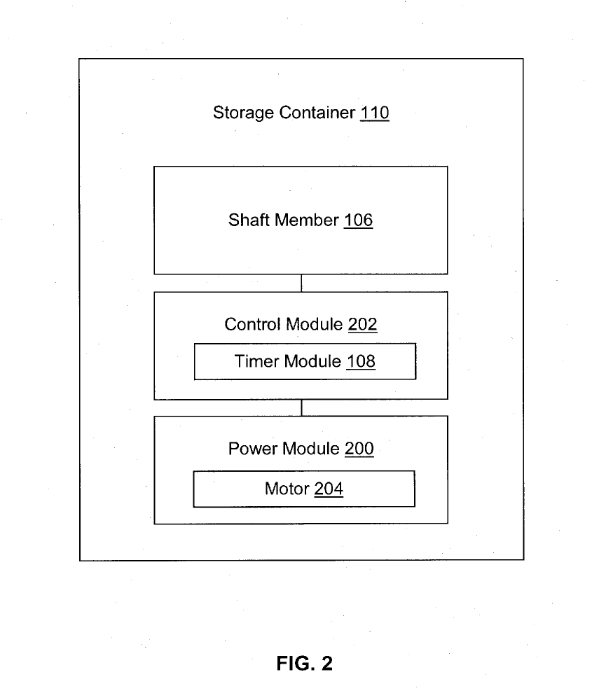

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “one embodiment,” “an embodiment,” and similar language throughout this specification may, but do not necessarily, all refer to the same embodiment, different embodiments, or component parts of the same or different illustrated invention. Additionally, reference to the wording “an embodiment,” or the like, for two or more features, elements, etc. does not mean that the features are related, dissimilar, the same, etc. The use of the term “an embodiment,” or similar wording, is merely a convenient phrase to indicate optional features, which may or may not be part of the invention as claimed.

Each statement of an embodiment is to be considered independent of any other statement of an embodiment despite any use of similar or identical language characterizing each embodiment. Therefore, where one embodiment is identified as “another embodiment,” the identified embodiment is independent of any other embodiments characterized by the language “another embodiment.” The independent embodiments are considered to be able to be combined in whole or in part one with another as the claims and/or art may direct, either directly or indirectly, implicitly or explicitly.

Finally, the fact that the wording “an embodiment,” or the like, does not appear at the beginning of every sentence in the specification, such as is the practice of some practitioners, is merely a convenience for the reader's clarity. However, it is the intention of this application to incorporate by reference the phrasing “an embodiment,” and the like, at the beginning of every sentence herein where logically possible and appropriate.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “comprising,” “including,” “containing,” “is, are,” “characterized by,” and grammatical equivalents thereof are inclusive or open-ended terms that do not exclude additional unrecited elements or method steps. “Comprising” is to be interpreted as including the more restrictive terms “consisting of” and “consisting essentially of.”

Illustrated by the figures, there is shown a mixing device 100 for mixing nail polish and other liquids. The mixing device 100 has a tubular housing member 102. Disposed in an interior 103 of the tubular housing member 102 is a compressible tubular casing member 104. In one embodiment of the invention, the compressible tubular casing member 104 encases a bottle of nail polish. For example, the compressible tubular casing member 104 may comprise a sponge, foam padding, and/or other compressible material. Additionally, in one embodiment of the invention, the compressible tubular casing member 104 is removably disposed in an interior 103 of the tubular housing member 102. For example, the compressible tubular casing member 104 may be slidably inserted into the tubular housing member 102. Alternatively, the tubular housing member 102 may support the compressible tubular casing member 104, and may have a securing mechanism for securing the compressible tubular casing member 104 to the tubular housing member 102, such as a lid, or ties.

Also shown by the illustrated figures, there is a shaft member 106 coupled to the tubular housing member 102. As illustrated, the shaft member 106 supports the tubular housing member 102 for mixing a bottle of nail polish. In addition, the shaft member 106 is in communication with a power module 200. The power module 200 provides power to the shaft member 106 for shaking and/or rotating the tubular housing member 102. For example, in one embodiment of the invention the power module 200 includes a motor 204, such as the electric motor of U.S. Pat. No. 5,399,013, which is incorporated by reference herein. Similarly, the power module 200 may include a battery.

More, the figures illustrate a control module 202, in communication with the power module 200. The control module 202 controls the provision of energy from the power module 200 to the shaft member 106. For example, the control module 202 may be include On/Off switch. In one embodiment of the invention, the control module includes a timer module 108, such as the Model T-1 Mini Countdown Timer by ElectronicsUSA at http://electronicsusa.com/desktoptimer.html. For example, the timer module 108 may be set to time mixing of nail polish from one to three minutes.

Further, there is illustrated by the figures a storage container 110 coupled to an end of the shaft member 106 opposite the tubular housing member 102. In one embodiment of the invention, the storage container 110 is configured to store accessories for manicures and pedicures, such as: bottles of nail polish; nail files; nail buffers; cotton balls; nail polish remover; nail polish thinner; metal balls; etc. Also, as illustrated, the timer module 108 is coupled to an exterior 111 of the storage container 110, and the power module 200 is disposed within the storage container 110.

In operation of one embodiment of the invention, a user picks a desired color of nail polish, contained in a nail polish bottle. Then, the user drops nail polish thinner and/or beads into the nail polish bottle with the nail polish. The user then inserts the nail polish bottle into a compressible tubular casing member 104 so that the compressible tubular casing member 104 encases the bottle. Next, the user places the compressible tubular casing member 104 in a tubular housing member 102 of a mixing device 100.

After the compressible tubular casing member 104 is placed in the tubular housing member 102, the user sets a timer module 108 for three minutes and turns the mixing device 100 on. The mixing device 100 then mixes the nail polish by shaking and/or rotating the nail polish bottle. After three minutes have elapsed, and the nail polish is mixed, the user removes the compressible tubular casing member 104 from the tubular housing member 102, and removes the nail polish bottle from the compressible tubular casing member 104. The user may then apply the mixed nail polish to nails.

It is understood that the above-described embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

For example, although the figures show the tubular housing member 102 disposed horizontally, the tubular housing member 102 may be disposed vertically, or at an angle. Similarly, although the figures illustrate the shaft member 106 coupled to a side of the storage container 110, the shaft member may be coupled to a top of the storage container.

It is also envisioned that the power module 200 could provide energy in the form of direct current or alternating current. For example, the power module 200 could include a battery. Likewise, the power module 200 could include a power cord for coupling to an electrical outlet.

It is further envisioned that the storage container 110 could include an interior space to store nail polish accessories such as: bottles of nail polish; nail files; nail buffers; cotton balls; nail polish remover; nail polish thinner; metal balls; etc. In addition, the storage container 110 could include a depression, cavity, and/or tray, for additional storage

It is expected that there could be numerous variations of the design of this invention. For example, the storage container 110 could be any shape appreciated in the art, such as, but not limited to: square, rectangular, hexagonal, or pyramidal. Additionally, it is envisioned that the mixing device 100 could be sized small enough for portability. For example, in one embodiment of the invention, the mixing device 100 could be six inches high, six inches wide, and six inches long.

Finally, it is envisioned that the components of the mixing device 100 may be constructed of a variety of materials. For example, compressible tubular casing member 104 may be constructed of any compressible material appreciated in the art, such as but not limited to: sponge, foam padding, rubber, plastic, and/or textiles. In addition, the components of the mixing device 100 may be constructed of any material appreciated in the art, such as, but not limited to: metal, plastic, rubber, wood, and/or glass.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. A mixing device for mixing nail polish and other liquids, comprising:
a) a tubular housing member, configured to house a bottle of nail polish;
b) a compressible tubular casing member, disposed in an interior of the tubular housing member, configured to encase a bottle of nail polish;
c) a shaft member, coupled to the tubular housing member, configured to support the tubular housing member;
d) a power module, in communication with the shaft member, configured to provide energy to the shaft member; and
e) a control module, in communication with the power module, configured to control the provision of energy from the power module to the shaft member; wherein the control module includes a timer module.

2. The mixing device of claim 1, wherein the compressible tubular casing member is removably disposed in an interior of the tubular housing member.

3. The mixing device of claim 2, wherein the power module comprises a motor.

4. The mixing device of claim 3, further comprising:
a) a storage container, coupled to an end of the shaft member opposite the tubular housing member, configured to store accessories for manicures and pedicures.

5. The mixing device of claim 4, wherein the timer module is coupled to an exterior of the storage container; and the power module is disposed within the storage container.

6. A mixing device for mixing nail polish and other liquids, consisting essentially of:
a) a tubular housing member, configured to house a bottle of nail polish;
b) a compressible tubular casing member, disposed in an interior of the tubular housing member, configured to encase a bottle of nail polish;
c) a shaft member, coupled to the tubular housing member, configured to support the tubular housing member;
d) a power module, in communication with the shaft member, configured to provide energy to the shaft member; and
e) a control module, in communication with the power module, configured to control the provision of energy from the power module to the shaft member; wherein the control module includes a timer module.

7. The mixing device of claim 6, wherein the compressible tubular casing member is removably disposed in an interior of the tubular housing member.

8. The mixing device of claim 7, wherein the power module comprises a motor.

9. The mixing device of claim 8, wherein the timer module is coupled to an exterior of the storage container; and the power module is disposed within the storage container.
